(19) United States
(12) Patent Application Publication
(10) Pub. No.: US 2010/0138755 A1
(43) Pub. Date: Jun. 3, 2010

(54) USE OF A VIRTUAL WORLD TO MANAGE A SECURED ENVIRONMENT

(76) Inventors: Gaurav N. Kulkarni, Denver, CO (US); Rick A. Hamilton, II, Charlottesville, VA (US); Anne R. Sand, Peyton, CO (US); James W. Seaman, Falls Church, VA (US)

Correspondence Address: HOFFMAN WARNICK LLC, 75 STATE ST, 14TH FLOOR, ALBANY, NY, 12207, US

(21) Appl. No.: 12/326,937

(22) Filed: Dec. 3, 2008

(51) Int. Cl. G06F 21/00; G06F 3/048

(52) U.S. Cl. 715/757; 726/1

(57) ABSTRACT

The present invention provides for using a virtual universe (VU) to validate user access and manage activities within a secured environment. The secured environment is associated with a security system. The VU and the security system are generated by a VU simulation engine by inserting an abstraction layer between the VU simulation engine. A plurality of application programming interfaces (APIs) are provided between the VU simulation engine and elements of the security system.

### CROSS-REFERENCE TO RELATED APPLICATIONS

This application is related in some aspects to commonly owned patent application Ser. No. 12/055,466, entitled “SYSTEM AND METHOD FOR AUTOMATICALLY GENERATING VIRTUAL WORLD ENVIRONMENTS BASED UPON EXISTING PHYSICAL ENVIRONMENTS”, assigned attorney docket number END920070249US1, filed Mar. 26, 2008, the entire contents of which are herein incorporated by reference.

### TECHNICAL FIELD OF THE INVENTION

The present invention provides for the use of virtual worlds or universes to aid in validating user access and managing activities within a secured environment so as to provide an accurate view of real world facilities and resources. Under aspects of the present invention, two dimensional (2D) and three dimensional (3D) virtual renditions of physical resources (e.g., people, objects, etc.) are used in consort with pre-existing security systems to aid in providing greater security for real-life monitored environments, such as computer data centers, bank vaults, manufacturing space, storefronts, and other manageable, secure assets.

### BACKGROUND OF THE INVENTION

Current managing mechanisms (e.g., RFID tags, cameras, etc.) are used to manage user access and activities within secure monitored environments, such as bank vaults, data centers and the like. These typically utilize two-dimensional (2D) monitoring tools (e.g., map on a screen) to show the location and movement of people. Many disparate authentication and authorization systems are used for verifying and granting permission to users. For example, badges, passwords, biometrics (e.g., fingerprint, retinal scanners, etc.) may be used. Additionally, security cameras are often placed around the secure monitored environment with staff hired to watch the cameras to notice individuals and/or activities that look suspicious.

However, these current security methods provide limited capabilities for managing user activities within secure locations. Two-dimensional views typically represent the people simply as dots or icons moving around on a video screen. Additionally, often it is not convenient to locate cameras in all locations of the monitored environment, such as on a battlefield. Viewing of a person's movement is limited to the placement, angles, and resolution of the physical cameras.

### SUMMARY OF THE INVENTION

In general, the present invention is directed to using virtual worlds or universes to validate user access and manage activities within secured environments. Aspects of the invention disclose methods for using virtual worlds, or virtual universes, to manage, authenticate/authorize and/or interact with individuals within a monitored or secure physical area or environment. An immersive, three-dimensional (3D) environment is provided as an enhanced graphical user interface (GUI) through the interplacement of an abstraction layer and a plurality of application programming interfaces (APIs) among current managing and security methods, virtual universes, and end users. The abstraction layer and APIs enable communication among various disparate components and modification of individual security mechanisms in the environment without impacting other components.

A first aspect of the present invention is directed to a method for using a virtual universe (VU) in consort with a monitored environment thereby validating user access and managing activities in a secured environment, the secured environment having a security system associated therewith, the method comprising: inserting an abstraction layer between a VU simulation engine configured to generate the VU and the security system; and providing a plurality of application programming interfaces (APIs) between the VU simulation engine and elements of the security system.

A second aspect of the present invention is directed to a system for using a virtual universe (VU) in consort with a monitored environment thereby validating user access and managing activities within a secured environment, the secured environment having a security system associated therewith, the system comprising: an abstraction layer in communication with a VU simulation engine configured to generate the VU and the security system; and a plurality of application programming interfaces (APIs) connected to the VU simulation engine and elements of the security system.

A third aspect of the present invention is directed to a computer program product in a computer readable medium for operating in a system comprising a network I/O, a CPU, and one or more databases, for implementing a method for using a virtual universe (VU) in consort with a secured environment thereby validating user access and managing activities within the secured environment, the secured environment having a security system associated therewith, the method comprising: inserting an abstraction layer between a VU simulation engine configured to generate the VU and the security system; and providing a plurality of application programming interfaces (APIs) between the VU simulation engine and elements of the security system.

A fourth aspect of the present invention is directed to a method for deploying an application for using a virtual universe (VU) in consort with a secured environment thereby validating user access and managing activities within the secured environment, the secured environment having a security system associated therewith, comprising: providing a computer infrastructure being operable to: insert an abstraction layer between a VU simulation engine configured to generate the VU and the security system; and provide a plurality of application programming interfaces (APIs) between the VU simulation engine and elements of the security system.

A fifth aspect of the present invention is directed to a business method for using a virtual universe (VU) in consort with a secured environment thereby validating user access and managing activities within the secured environment, the secured environment having a security system associated therewith, the business method comprising: managing a network that includes at least one computer system that performs the process described herein; and receiving payment based on the managing.

The illustrative aspects of the present invention are designed to solve the problems herein described and other problems not discussed.

### BRIEF DESCRIPTION OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative environment for using a virtual world to validating user access and managing activities within a secured environment according to an embodiment of the invention.

FIG. 2 shows an illustrative diagram of a portion of the system in FIG. 1 according to an embodiment of the invention.

FIG. 3 shows another illustrative diagram of a portion of the system in FIG. 1 according to an embodiment of the invention. [0016] FIG. 4 shows an illustrative flow diagram of the method in according to an embodiment of the invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

The present invention provides for using a virtual world or universe to validate user access and manage activities within a secured environment.

As indicated above, aspects of the invention provide an improved solution for secured environments. In an embodiment of the invention, a method for using a virtual universe (VU) in consort with a “real-life” or “real-world” secured environment is provided for thereby validating user access and managing activities in the secured environment, the secured environment having a security system associated therewith. The method includes: inserting an abstraction layer between a VU simulation engine configured to generate the VU and the security system; and providing a plurality of application programming interfaces (APIs) between the VU simulation engine and elements of the security system. As used herein, unless otherwise noted, the term “set” means one or more (i.e., at least one); and, the phrase “any solution” means any now known or later developed solution.

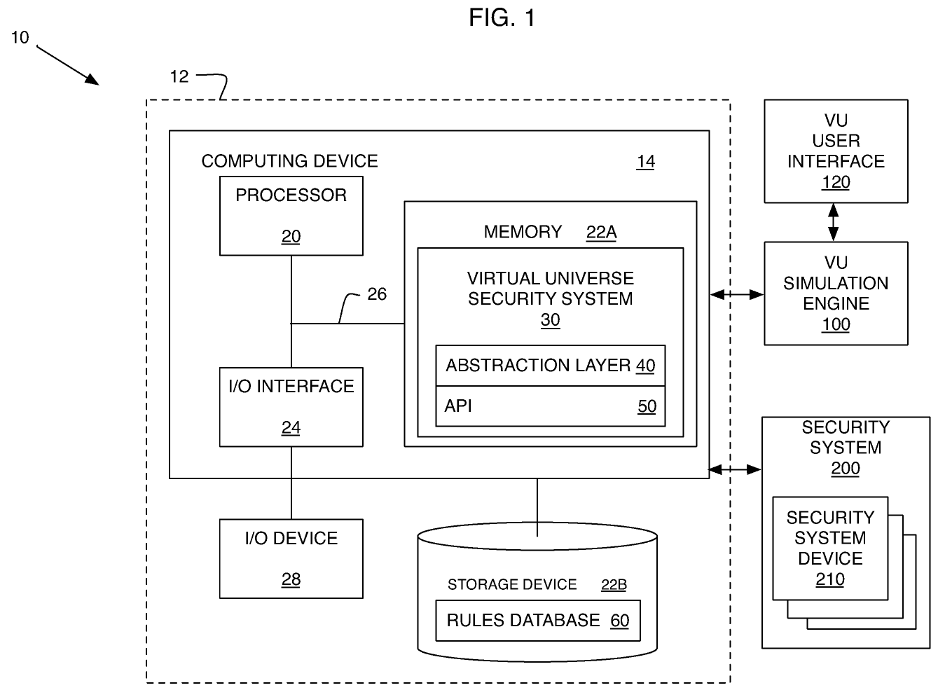

Turning to the drawings, FIG. 1 shows an illustrative environment 10 for using a virtual world to validate user access and manage activities within a secured environment according to an embodiment of the invention. To this extent, environment 10 includes a computer system 12 that can perform the process described herein in order to use a virtual world or universe to validate user access and manage activities within a secured environment. In particular, computer system 12 is shown including a computing device 14 that comprises a virtual universe security system 30, which makes computing device 14 operable for use a virtual world or universe to validate user access and manage activities within a secured environment, by performing the process described herein.

Computing device 14 is shown including a processor 20, a memory 22A, an input/output (I/O) interface 24, and a bus 26. Further, computing device 14 is shown in communication with an external I/O device/resource 28 and a storage device 22B. In general, processor 20 executes program code, such as virtual universe security system 30, which is stored in a storage system, such as memory 22A and/or storage device 22B. While executing program code, processor 20 can read and/or write data to/from memory 22A, storage device 22B, and/or I/O interface 24. Bus 26 provides a communications link between each of the components in computing device 14. I/O device 28 can comprise any device that transfers information between a user 16 and computing device 14. To this extent, I/O device 28 can comprise a user I/O device to enable an individual user 16 to interact with computing device 14 and/or a communications device to enable a system user to communicate with computing device 14 using any type of communications link.

In any event, computing device 14 can comprise any general purpose computing article of manufacture capable of executing program code installed thereon. However, it is understood that computing device 14 and virtual universe security system 30 are only representative of various possible equivalent computing devices that may perform the process described herein. To this extent, in other embodiments, the functionality provided by computing device 14 and virtual universe security system 30 can be implemented by a computing article of manufacture that includes any combination of general and/or specific purpose hardware and/or program code. In each embodiment, the program code and hardware can be created using standard programming and engineering techniques, respectively.

Similarly, computer system 12 is only illustrative of various types of computer systems for implementing aspects of the invention. For example, in one embodiment, computer system 12 comprises two or more computing devices that communicate over any type of communications link, such as a network, a shared memory, or the like, to perform the process described herein. Further, while performing the process described herein, one or more computing devices in computer system 12 can communicate with one or more other computing devices external to computer system 12 using any type of communications link. In either case, the communications link can comprise any combination of various types of wired and/or wireless links; comprise any combination of one or more types of networks; and/or utilize any combination of various types of transmission techniques and protocols.

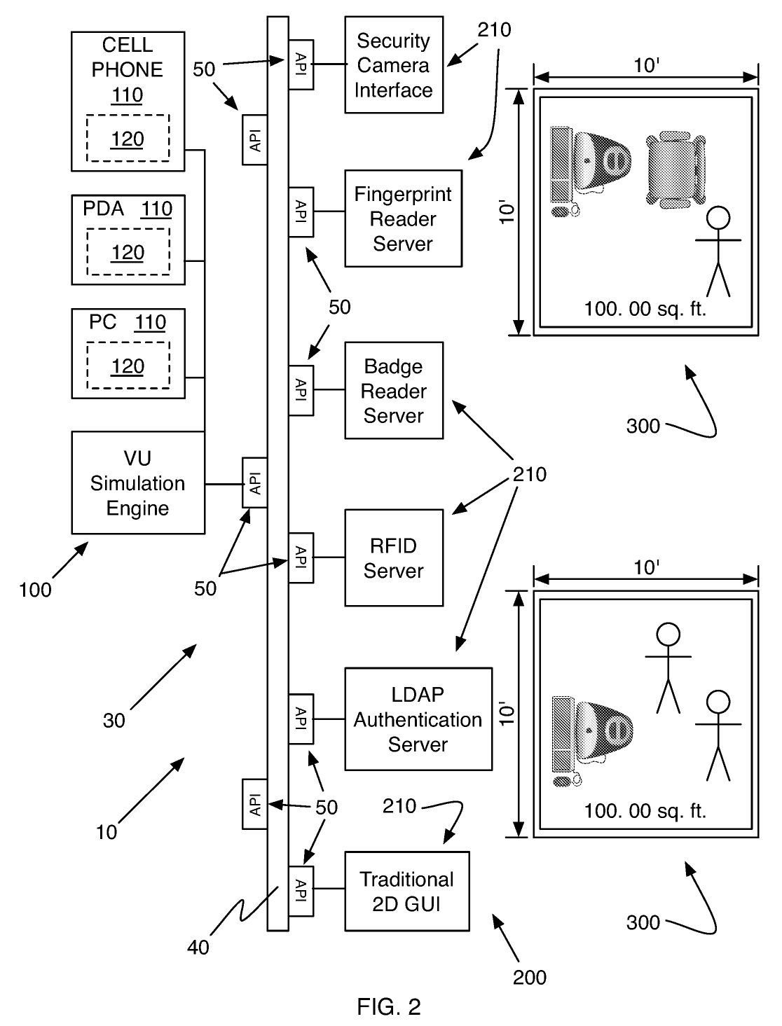

As discussed herein, virtual universe security system 30 enables computer system 12 to use a virtual world or universe to validate user access and manage activities within a secured environment. To this extent, virtual universe security system 30 is shown in FIG. 2, as including an abstraction layer 40 and a plurality of APIs 50. Operation of each of these elements is discussed further herein. However, it is understood that some of the various elements shown in FIG. 1 can be implemented independently, combined, and/or stored in memory of one or more separate computing devices that are included in computer system 12. Further, it is understood that some of the elements and/or functionality may not be implemented, or additional elements and/or functionality may be included as part of computer system 12.

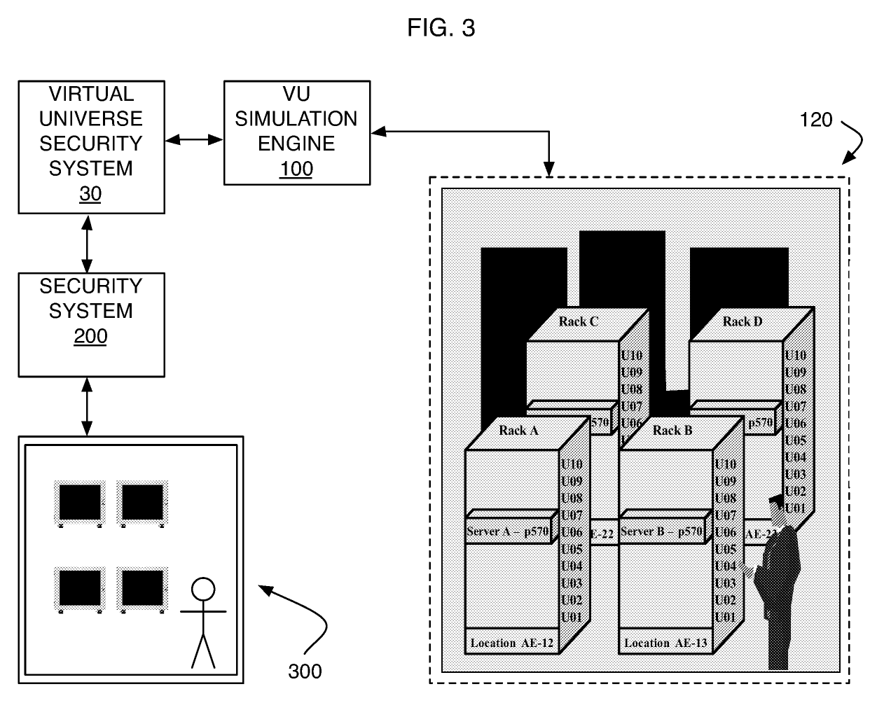

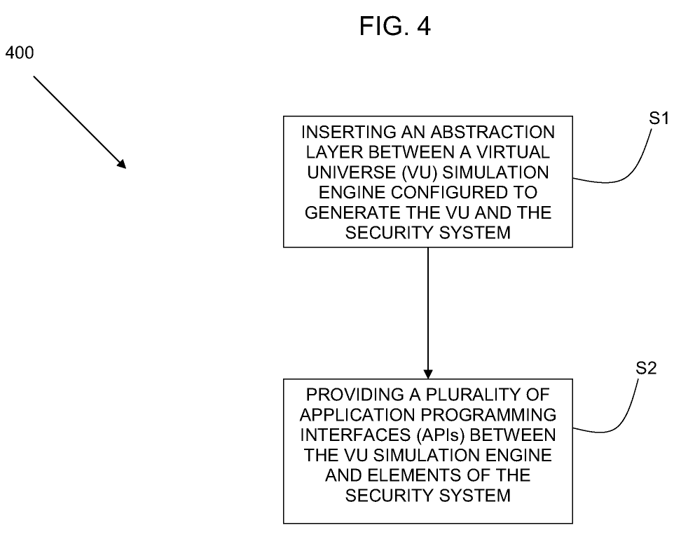

Aspects of the invention provide an improved solution for managing a secured environment. To this extent, FIGS. 2 and 3 show illustrative diagrams of an application of the system 10 in FIG. 1 in consort with an existing security system 200 and VU simulation engine 100, according to embodiments of the invention.

As shown, for example, in FIG. 2, the virtual universe security system 30 may include an abstraction layer 40 and a plurality of APIs 50 between a security system 200 of any now known or later developed technology and at least one virtual universe (VU) simulation engine 100 thereby providing enhanced user management and security management capabilities.

The abstraction layer 40 may contain the interface and rules to translate among the “traditional” security system 200 and the VU simulation engine 100. Similarly, the plurality of APIs 50 are attached to the abstraction layer 40 so as to enable modification and/or interchange of any component (e.g., 210) of the overall system without major changes to the other components. The APIs 50 further allow disparate systems to communicate without detailed awareness of the other elements. The VU simulation engine 100 does not need to “understand” the details of the various security system elements 210 (e.g., biometric fingerprint scanners, badge readers, etc.). The VU simulation engine 100 views avatars and objects in familiar ways; that is with characteristics and actions that may be taken by or upon them. Similarly, the security system elements 210 and any concomitant software of the security system 200 does not need to have “knowledge” of the 3D VU interface 120 or VU simulation engine 100.

For example, new type of security system element 210 such as a biometric device (e.g., badge reader) may then be added to the security system 200. The VU simulation engine 100 would only know that it is a 3D object with functions that may call upon the device 210 and change its characteristics. Similarly, a fingerprint reader provided by Vendor A may be replaced with a retinal scanning system from Vendor B without affecting the interface to the VU simulation engine 100. Similarly, an Active Directory authentication server may be replaced with an OpenLDAP open source LDAP authentication server without requiring any changes to the VU simulation engine 100.

According to an embodiment of the invention, a method for using a virtual world to validate user access and manage activities within a secured environment may start with creating a three-dimensional (3D) virtual universe (VU) representation of a real-world secured environment 300. The real-world secured environment 300 may be any secure or semi-secure area that is monitored in some fashion. For example, it may be a restricted data center, a bank vault, a government building and/or the like. In any event, a 3D VU is created that represents the secured environment 300 using now known or later developed VU simulation technologies such as a VU simulation engine 100. The 3D VU is thereby rendered on at least one VU Interface 120, typically located on an output device 110 (e.g., personal computer (PC), cell phone, personal display apparatus (PDA), etc.).

The method further includes providing a real-world security system 200 that provides validating and managing means to the secured environment 300. The security system 200 may utilize any now known or later developed technologies. An abstraction layer 40 and a plurality of APIs 50 are inserted between the VU simulation engine 100 and security system 200.

The method may further comprise creating managing avatars to represent people and/or creating object avatars to represent objects of interest. The creating of avatars can further comprise linking characteristics of the avatar (e.g., managing avatar, object avatar) directly to a status of the individual and/or an object related to the individual. For example, visitors wear red clothing to represent that they are highly visible as they move about and/or they have a certain specified security clearance level. Similarly, a person having the highest security clearance level may have an avatar that has a certain hat, badge, etc. to signify the security clearance level. The creating of avatars may further comprise defining rules for representing movement of individuals (e.g., show walking, running, crawling, moving vertically, etc.).

The method may further comprise creating a new and/or accessing an existing rules database 60 (FIG. 1) for providing authentication and authorization means for individuals. Authentication means include, for example, means required for each area in the secured environment 300 (e.g., fingerprint reader, badge access, etc.). Similarly, authorization means may include defining what areas and what times a person can access the areas.

The method may further comprise populating the rules database 60 for management functions including, for example, avatar and security system 200 permissions. For example, the populating may further comprise enabling management of user authentication and/or authorization through the VU. Populating may comprise enabling addition, removal, and/or modification of various security system components 210 (e.g., replace LDAP server).

The method may further comprise establishing rules for an interface between any real-life camera systems and the VU simulation engine 100 display of video in the VU. Also, the method may comprise establishing the ability to record machinima of avatar movement and actions within in the VU. The method may also employ an omniscient view of VU available via simulator to easily view any place within the entire VU area representing the secured environment 300. The method may also comprise establishing rules for mobile user communication between VU and the traditional security system 200.

In this manner the method may provide several benefits over current 2D methods by managing people with this 3D immersive interface. Benefits may include the ability to examine 3D representation of the secured environment vs. a 2D “blueprint” view. There are increased options for representations of people as avatars and objects as 3D images vs. dots on a screen as well as the representation of people's movements as avatars traverse a 3D environment vs. moving the dots on a screen. Similarly, the invention provides the ability to display vertical movement combined with horizontal movement, allowing to show a person climbing and the like. The invention also may provide the ability to move around within the 3D environment (e.g., teleport, walk, fly, zoom in, etc.) enabling viewing from any angle. The invention also offers an enhanced user interface options for managing the secured environment as well as simplified communications among disparate systems via APIs 50.

Under aspects of the present invention the use of managing avatar and managing objects may be employed. For examples, a managing avatar may be linked to a real person being monitored by the security system 200. The managing avatar characteristics, location and movement are controlled and displayed automatically based upon a user profile and managing data about the real person's movement. Additionally, the movement of limbs may also be monitored to show more detailed actions, such as reaching for something on a shelf. This may be accomplished via any known or later developed movement managing means (e.g., sensors in gloves, boots, video recognition, etc.). In an embodiment, the identity of the real person and real-life permission may be displayed with the associated managing avatar.

The managing object may be any non-human animal or inanimate object whose movement must be managed with the secured environment 300. The managing object may be represented by the virtual simulation as a 3D object rendering on the VU interface 120 that moves in synch with the real-life managing object.

In an embodiment real-life authorization permissions may be shown managing avatar characteristics. Managing avatar characteristics, including visual appearance, may be automatically modified to reflect the corresponding persons' authorization levels within the real-life secured environment 300. For example, visitors may appear wearing orange clothing and manager wear green clothing and baseball cap.

In another embodiment real-life person and object movement may be displayed as managing avatar movement. For example, a rules database may be built defining how representations of managing avatar movement may be customized based on real-world movement of a person in secured environment 300. Additionally, managing object movement reflects movement of an object in the real world secured environment 300. As an example, individuals moving at less than 3 mph are shown to be walking avatars, while individuals moving at a rate greater than 3 mph are shown to be running. If a managing signal indicates the person is within 1 foot of the floor for a period of time (e.g., greater than 1 minute), that the avatar is displayed as laying down. If an individual moves in a vertical direction with no vertical moving equipment (e.g., elevators) nearby, then the avatar is shown climbing. Similarly, areas that have known movement-enhancing equipment (e.g., elevator, escalator, moving sidewalk, etc.) may show the avatar moving within the device. For example, if a RFID shows person moving vertically within the real-life elevator, he/she is shown as such in the representation of it within the VU. This prevents the visual rendering of a person climbing, which may trigger suspicion.

Table 1 shows database entries defining how real-life movements of managed individuals may be depicted in VU representation. Table 1:

| Avatar Motion | Person Movement |
|---|---|
| Walk | Move horizontally <3 mph |
| Run | Move horizontally >3 mph |
| Climb | Move horizontally in area that does not |
| | contain elevator/escalator |
| Lay | Badge <2 ft above ground for >1 |
| | minute |
| Crawl | Badge <2 ft above ground, moving |
| | horizontally |
| Elevator | If person is inside elevator in real life, |
| | show as such in VU |

In an embodiment a managing object may be used with a managing avatar. For example, in the real-world, a person is assigned to supervise a briefcase containing confidential documents. The person is managing in a virtual universe as a managing avatar and the briefcase is represented as a managing object. As both the person and briefcase move within the real world, the VU objects move within VU representation of secure environment. If the person and briefcase are separated, it is shown in the VU and screens showing 3D locations of each are automatically opened for a security guard to see.

In another embodiment a managing object may be used to convey multiple characteristics. The managing object may convey information including temperature, humidity, etc. For example, an explosive device is managed via a VU interface. A RFID tag is attached to explosive device reports that the temperature of the device has increased to unsafe levels and that humidity has also increased. The VU interface changes the color of the 3D representation of the object to red; sends and alert; and, causes a view of the surrounding area to be projected on a screen of a responsible person. The person responsible for safety of the environment is alerted and realizes that the air conditioning has failed and is able to remedy the problem.

In another embodiment a managing avatar is used to guide an entity. For example, a remote systems administrator may use a managing avatar to guide a technician to a specific location in a data center to fix a broken cable.

In another embodiment of the present invention various management functions may be enabled through the VU interface 120, as compared to a traditional GUI. Various methods for requesting and/or managing user authentication and/or authorization mechanisms with a VU interface 120 may be used under the present invention. For example, a security guard or system administrator may modify real-life person authorization levels using 3D VU interface 120, interfacing with managing avatar and/or managing objects. Similarly, a person may request and receive upgraded authorization permissions using VU interface 120.

Various scenarios are conceivable for enabling management functions through the VU interface 120 including, for example, adding authorization through interaction with an avatar via the VU interface 120. A process may include a user with security guard-type permissions logs into the 3D VU. The user “guard” can “right-click” on guest avatar. The guard could then select “Authorize/Raised Floor”. The VU simulation engine 120 notifies the abstraction layer 40 which, in turn, notifies the traditional authorization rules database 60. The authorization rules database 60 adds user to “Raised Floor” group in LDAP server and confirms changes were made successfully. The guest avatar's clothing is changed to blue to indicate an authorized person.

Another scenario example is adding authorization through object interaction within the VU interface 120. A user with security guard permission logs into the 3D VU. The guard “right-clicks” on graphical representation of a specific badge reader within the VU and then “right-clicks” on it and selects “Add Access”. A hierarchical menu is presented listing all staff. The guard then selects the staff member to add to authorization for this particular badge reader. The real-life badge reader interface is updated, which subsequently updates the user access databases.

Another scenario example is where an authorization request and response is through the VU. For example, a staff member needs to be provided access to a room with a locked door and badge reader. Traditionally, this person may have to fill out a paper form. Under aspects of the present invention the staff member uses the VU interface 120 to request and be notified of authorized changes. For example, the staff member logs into VU under his/her corporate user ID, using VU interface 120 on a device (e.g., handheld PDA). The staff member teleports or walks to badge reader and clicks on badge reader and selects “Access Request”. The VU simulation engine 100 sends request to the abstraction layer 40, which translates and forwards request to traditional badge reader software interface. The badge reader interface sends a workflow request to a human security guard. The security guard grants access through badge reader software interface, which sends authorization notification to abstraction layer 40. The abstraction layer 40, in turn, sends authorization notification to VU simulation engine 100 which forwards authorization notification to avatar. The VU simulation engine 100 modifies the avatar appearance or characteristics to reflect new permission and modifies badge reader object so that it now appears green, for example, to this avatar, indicating that he/she has access. If the avatar is logged off, he/she receives notification of updated permission upon the next login.

Under aspects of the present invention the abstraction layer 40 also provides an interface with any security camera system of now know or later developed technologies. This enables viewing of live or recorded video without having to leave the VU interface 120. The VU may show graphical representation of scenes caught by real-life video cameras. For example, real-life video may be displayed within the VU when a security guard or systems administrator “clicks” on any camera object within the VU and selects, for example, “Show video/April 23, 2007/12:00”. This act would begin a playing of the prerecorded video on a simulated large screen projector within the VU. Similarly, “Show video/Live” could begin playing a live video from a particular camera in a new pop-up window.

In another embodiment the VU interface 120 and security system 200 may be used with a mobile communication device thereby providing benefits including real-time interaction with people within the secure environment via VU interface. The mobile device may be equipped with a web cam to aid in visual verification of an individual's identity and that he is in the surroundings depicted in the 3D world. The mobile device may further include biometrics (e.g., fingerprint scanner) for verification of the individual. This would automatically update authentication within the VU.

Various scenarios using this feature include the use of managing avatars in the secured environment 300. For example, young teenagers are outfitted with managing mechanisms and my also optionally carry a mobile device. Once the teenagers enter a mall, they would appear as avatars within a VU representation of the mall. Parents may log into the VU through the Internet from their home to watch their teenagers as they shop and traverse through the mall. The parents can use VU interface to select particular stores to mark as restricted for the teenagers. Additionally, the parents may appear as avatars within the VU. They could be flagged as avatars that are ephemeral and do not represent real people in the mall. When the teenagers enter a restricted store, the VU interface flags parents with a warning. The parents could then query the teenagers about why they are in the restricted store, so they sent a text message via their VU interface 120. The text message appears on the child's mobile device, where the child may also see the VU interface 120. The parents and children may communicate via home computer and/or mobile device via VU interface 120.

Another scenario includes the interaction among individuals as they move about the environment. For example, staff and visitors are required to carry a mobile communications device with them at all times so as to secure an environment. When a security guard wants to communicate with them, he/she speaks and/or texts to their respective avatar. A signal is then sent to the mobile communications device, opening an interface to the VU. The guard may challenge the visitor via the mobile communications device (e.g., VOIP communications) or texting within VU GUI, asking him/her why he/she is walking a restricted area. The queried visitor provides valid rationale for their location. The guard then provides access using VU interface (e.g., changes color of visitor's shirt to blue) to show that visitor is now authorized to walk in the restricted area.

Referring to FIG. 3, another embodiment depicting the interaction between the security system 200, virtual universe security system 30 and the VU simulation engine 100 is shown. The VU user interface 120 shows a 3D VU rendering of monitored environment, in this example, a data center that includes four (4) server racks (i.e., Rack A, Rack B, Rack C, Rack D) and an avatar which are associated with the secured environment (e.g., “real-world” data center) 300 having four server racks and a real person in the data center 300 that has the security system 200 associated therewith.

Referring to FIG. 4, a flow diagram 400 of a method according an embodiment of the invention is depicted. Using a VU with a secured environment associated with a security system to validate user access and manage activities in the secured environment includes the following steps: (step S1) inserting an abstraction layer between a VU simulation engine configured to generate the VU and the security system; and (step S2) providing a plurality of application programming interfaces (APIs) between the VU simulation engineer and elements of the security system.

In another embodiment, the invention provides a computer program stored on a computer-readable medium, which when executed, enables a computer system to use a virtual world or universe to validate user access and manage activities within secured environments. To this extent, the computer-readable medium includes program code, such virtual universe security system 30 (FIG. 1), which implements the process described herein. It is understood that the term “computer-readable medium” comprises one or more of any type of tangible medium of expression capable of embodying a copy of the program code (e.g., a physical embodiment). In particular, the computer-readable medium can comprise program code embodied on one or more portable storage articles of manufacture, on one or more data storage portions of a computing device, such as memory 22A (FIG. 1) and/or storage system 22B (FIG. 1), as a data signal traveling over a network (e.g., during a wired/wireless electronic distribution of the computer program), on paper (e.g., capable of being scanned and converted to electronic data), and/or the like.

In another embodiment, the invention provides a method of deploying a system for using a virtual world or universe to validate user access and manage activities within secured environments. In this case, a computer system, such as computer system 12 (FIG. 1), can be obtained (e.g., created, maintained, having made available to, etc.) and one or more programs/systems for performing the process described herein can be obtained (e.g., created, purchased, used, modified, etc.) and deployed to the computer system. To this extent, the deployment can comprise one or more of: (1) installing program code on a computing device, such as computing device 14 (FIG. 1), from a computer-readable medium; (2) adding one or more computing devices to the computer system; and (3) incorporating and/or modifying one or more existing devices of the computer system, to enable the computer system to perform the process described herein.

In still another embodiment, the invention provides a business method that uses a virtual world or universe to validate user access and manage activities within secured environments, which enables users to perform the process described herein on a subscription, advertising, and/or fee basis. That is, a service provider could offer to manage a network and/or a computer system 12 (FIG. 1) that allows users to use a virtual world or universe to validate user access and manage activities within secured environments as described herein. In this case, the service provider can manage (e.g., create, maintain, support, etc.) a virtual and/or physical network that enables users to communicate content using computer systems, such as computer system 12, that perform the process described herein. In return, the service provider can receive payment from the user(s) under a subscription and/or fee agreement, receive payment from the sale of advertising to one or more third parties, and/or the like.

As used herein, it is understood that “program code” means any set of statements or instructions, in any language, code or notation, that cause a computing device having an information processing capability to perform a particular function either directly or after any combination of the following: (a) conversion to another language, code or notation; (b) reproduction in a different material form; and/or (c) decompression. To this extent, program code can be embodied as any combination of one or more types of computer programs, such as an application/software program, component software/a library of functions, an operating system, a basic I/O system/driver for a particular computing, storage and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for using a virtual universe (VU) in consort with a secured environment thereby validating user access and managing activities within the secured environment, the secured environment having a security system associated therewith, the method comprising:
inserting an abstraction layer between a VU simulation engine configured to generate the VU and the security system; and
providing a plurality of application programming interfaces (APIs) between the VU simulation engine and elements of the security system.

2. The method of claim 1 further comprising creating a three-dimensional (3D) virtual universe (VU) representative of the secured environment.

3. The method of claim 2, the creating further comprising at least one of:
creating a managing avatar configured to represent a person in the secured environment; and
creating an object avatar configured to represent an object in the secured environment.

4. The method of claim 1, further comprising:
managing a person or an object in the secured environment; and
authorizing an activity of the person or the object in the secured environment.

5. The method of claim 1, further comprising:
providing a rules database for providing one of authentication and authorization for the secured environment.

6. The method of claim 5, the providing further comprising populating the rules database with avatar permission rules for the VU.

7. The method of claim 1 the security system including a camera system and further comprising establishing rules for an interface between the camera system and the VU simulation engine.

8. The method of claim 1 further comprising the VU simulation engine providing a view in the VU that fully represents the secured environment.

9. A computer program product in a computer readable medium for operating in a system comprising a network I/O, a CPU, and one or more databases, for implementing a method for using a virtual universe (VU) in consort with a secured environment thereby validating user access and managing activities within the secured environment, the secured environment having a security system associated therewith, the method comprising:
inserting an abstraction layer between a VU simulation engine configured to generate the VU and the security system; and
providing a plurality of application programming interfaces (APIs) between the VU simulation engine and elements of the security system.

10. The computer program product of claim 9, the method further comprising creating a three-dimensional (3D) virtual universe (VU) representative of the secured environment.

11. The computer program product of claim 10, the creating further comprising at least one of:
creating a managing avatar configured to represent a person in the secured environment; and
creating an object avatar configured to represent an object in the secured environment.

12. The computer program product of claim 9, further comprising:
managing a person or an object in the secured environment; and
authorizing an activity of the person or the object in the secured environment.

13. The computer program product of claim 9, further comprising:
providing a rules database for providing one of authentication and authorization for the secured environment.

14. The computer program product of claim 13, the providing further comprising populating the rules database with avatar permission rules for the VU.

15. The computer program product of claim 13, the security system including a camera system and further comprising establishing rules for an interface between the camera system and the VU simulation engine.

16. The computer program product of claim 9, the method further comprising the VU simulation engine providing a view in the VU that fully represents the secured environment.

17. A system for using a virtual universe (VU) in consort with a secured environment thereby validating user access and managing activities within the secured environment, the secured environment having a security system associated therewith, the system comprising:
an abstraction layer in communication with a VU simulation engine configured to generate the VU and the security system; and
a plurality of application programming interfaces (APIs) connected to the VU simulation engine and elements of the security system.

18. The system of claim 17, the VU comprising at least one of:
a managing avatar configured to represent a person in the secured environment; or
an object avatar configured to represent an object in the secured environment.

19. A program product stored on a computer readable medium, which when executed, provides for using a virtual universe (VU) in consort with a secured environment thereby validating user access and managing activities within the secured environment, the secured environment having a security system associated therewith, the computer readable medium comprising program code for:
inserting an abstraction layer between a VU simulation engine configured to generate the VU and the security system; and
providing a plurality of application programming interfaces (APIs) between the VU simulation engine and elements of the security system.

20. A method for deploying an application for using a virtual universe (VU) in consort with a secured environment thereby validating user access and managing activities within the secured environment, the secured environment having a security system associated therewith, comprising:
providing a computer infrastructure being operable to:
insert an abstraction layer between a VU simulation engine configured to generate the VU and the security system; and
provide a plurality of application programming interfaces (APIs) between the VU simulation engine and elements of the security system.
